(19) United States
(12) Patent Application Publication
(10) Pub. No.: US 2025/0127226 A1
(43) Pub. Date: Apr. 24, 2025

(54) AEROSOL GENERATING DEVICE AND AEROSOL GENERATING SYSTEM

(71) Applicant: KT&G CORPORATOIN, Daejon (KR)

(72) Inventors: Dong Sung KIM, Seoul (KR); Yong Bum KWON, Guyeonggi-do (KR); Yong Hwan KIM, Gyeonggi-do (KR); Hun II LIM, Seoul (KR)

(73) Assignee: KT&G CORPORATION, Daejeon (KR)

(21) Appl. No.: 18/579,945

(22) PCT Filed: Sep. 26, 2023
(86) PCT No.: PCT/KR2023/014930

§ 371 Date: Jan. 17, 2024

(30) Foreign Application Priority Data
Oct. 5, 2022 (KR) 10-2022-0127392
Jan. 13, 2023 (KR) 10-2023-0005526

(51) Int. Cl. A24F 40/465; A24D 1/04; A24D 1/20; A24F 40/20; A24F 40/51; A24F 40/53; A24F 40/57; H05B 6/10

(52) U.S. Cl. CPC A24F 40/465; A24D 1/045; A24D 1/20; A24F 40/20; A24F 40/51; A24F 40/53; A24F 40/57; H05B 6/105

(57) ABSTRACT

An aerosol generating system includes an aerosol generating article, which includes a first medium portion including first aerosol generating materials, and a second medium portion arranged adjacent to one end of the first medium portion and including second aerosol generating materials, and an aerosol generating device, which includes a housing including an accommodation space configured to accommodate the aerosol generating article, and a heating element arranged to surround at least a part of the aerosol generating article accommodated in the accommodation space to heat the aerosol generating article, wherein an area of the heating element surrounding the first medium portion is different from an area of the heating element surrounding the second medium portion.

### TECHNICAL FIELD

Embodiments relate to an aerosol generating article and an aerosol generating system including the aerosol generating article, and more particularly, to an aerosol generating system that may generate an aerosol through induction heating.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on a heated aerosol generating device is being actively conducted.

Recently, there is an increasing demand for a method of efficiently generating an aerosol by variously arranging various components in an aerosol generating article. Accordingly, research on a method of providing an optimal smoking experience to a user by using an aerosol generating article or an aerosol generating device for generating an aerosol by heating is actively being conducted.

### DISCLOSURE

### Technical Problem

An embodiment according to the present disclosure provides the best smoking experience to users by generating an aerosol heated to a preset temperature without burning an aerosol generating article including various components variously arranged therein.

Objects to be achieved by embodiments of the present disclosure are not limited to the objects described above, and objects not described will be clearly understood by those skilled in the art to which the embodiments belong from the present specification and accompanying drawings.

### Technical Solution

An aerosol generating system according to an embodiment includes an aerosol generating article, which includes a first medium portion including first aerosol generating materials, and a second medium portion arranged adjacent to one end of the first medium portion and including second aerosol generating materials, and an aerosol generating device, which includes a housing including an accommodation space for accommodating the aerosol generating article and a heating element arranged to surround at least a part of the aerosol generating article accommodated in the accommodation space to heat the aerosol generating article, wherein an area of the heating element surrounding the first medium portion is different from an area of the heating element surrounding the second medium portion.

### Advantageous Effects

Aerosol generating systems according to various embodiments of the present disclosure may increase a sense of smoking of a user by adjusting inhalation resistance.

In addition, aerosol generating systems according to various embodiments of the present disclosure may maintain a uniform amount of atomization during a puff action.

### DESCRIPTION OF DRAWINGS

FIG. 1 is a perspective view of an aerosol generating system according to an embodiment.

FIG. 2 is an enlarged view of some components of an aerosol generating system according to an embodiment.

FIGS. 3A and 3B illustrate an aerosol generating article according to an embodiment.

FIGS. 4A and 4B illustrate an aerosol generating article according to another embodiment.

FIGS. 5A and 5B illustrate an aerosol generating article according to another embodiment.

FIG. 6 is a view illustrating an aerosol generating system according to an embodiment.

FIG. 7A is a graph illustrating a change in the amount of atomization according to a puff action of an aerosol generating system according to an embodiment.

FIG. 7B is a graph illustrating a change in the amount of atomization according to a puff action of an aerosol generating system according to another embodiment.

FIG. 7C is a graph illustrating a change in the amount of atomization according to a puff action of an aerosol generating system according to another embodiment.

FIG. 8 is a view illustrating an aerosol generating system according to an embodiment.

FIG. 9 is a flowchart illustrating an operating method of an aerosol generating device, according to an embodiment.

FIG. 10 is a block diagram of an aerosol-generating device according to another embodiment.

### BEST MODE

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

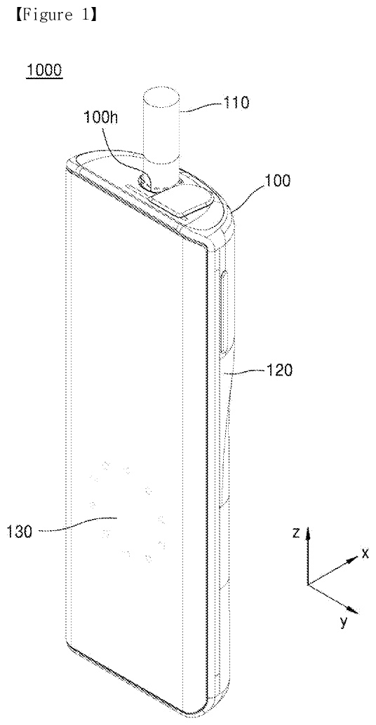

FIG. 1 is a perspective view of an aerosol generating system according to an embodiment.

Referring to FIG. 1, an aerosol generating system 1000 according to an embodiment may include an aerosol generating device 100 which may include a housing 120 into which an aerosol generating article 110 may be inserted.

In one embodiment, the housing 120 forms the entire appearance of the aerosol generating device 100 and may include an internal space (or an ‘arrangement space’) in which components of the aerosol generating device 100 may be arranged. Although the drawing illustrates an embodiment in which a cross section of the housing 120 is formed in a semicircular shape as a whole, the shape of the housing 120 is not limited thereto. Depending on embodiments (not illustrated), the housing 120 may be formed in a cylindrical shape as a whole or in a polygonal column (for example, a triangular column or a quadrangular column) shape.

In one embodiment, components for generating an aerosol by heating an aerosol generating article 110 inserted into the housing 120 and components for outputting a screen for a state of the aerosol generating device 100 may be arranged in the internal space of the housing 120, and a detailed description thereof is given below.

According to one embodiment, the housing 120 may include an opening 100h through which the aerosol generating article 110 may be inserted into the housing 120. At least a part of the aerosol generating article 110 may be inserted into or accommodated in the housing 120 through the opening 100h.

As the aerosol generating article 110 inserted into or accommodated in the housing 120 is heated inside the housing 120, an aerosol may be generated. The generated aerosol may be discharged to the outside of the aerosol generating device 100 through the inserted aerosol generating article 110 and/or a space between the aerosol generating article 110 and the opening 100h, and a user may inhale the discharged aerosol.

The aerosol generating device 100 according to the embodiment may further include a display 130 for displaying visual information.

In one embodiment, at least a part of the display 130 may be exposed to the outside of the housing 120. For example, at least a part of the display 130 may be exposed through an external cover glass of the housing 120.

In one embodiment, the display 130 may include a display panel and a touch panel that receives a touch input. For example, the display panel may include a light emitting element (for example, an organic light emitting diode (OLED)) or a light emitting diode (LED) that emits light based on signals supplied from a scan line and a data line. The touch panel may detect a change in electrical characteristics (for example, capacitance, radio waves, and so on) according to a touch input of a user, and positional information including the detected change may be transmitted to a processor.

In one embodiment, the display 130 may display, through the display panel, a user interface that is converted according to a touch input received through the touch panel. In this case, the display 130 may be composed of a stacked structure of the display panel and the touch panel.

The aerosol generating device 100 may provide various types of visual information to a user through the display 130. For example, the aerosol generating device 100 may display, on the display 130, preheating and heating information, battery remaining amount information, time and date information, use mode information, weather information, Bluetooth connection information, and so on of the aerosol generating article 110. The information displayed on the display 130 is an example and is not limited to the embodiment described above.

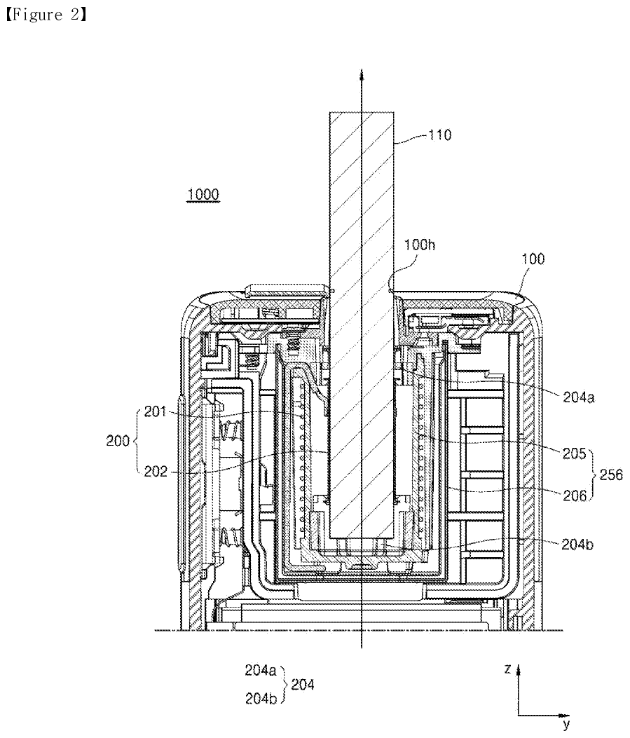

FIG. 2 is an enlarged view of some components of an aerosol generating system according to an embodiment.

Referring to FIG. 2, an aerosol generating system 1000 according to an embodiment may include an aerosol generating article 110 and an aerosol generating device 100 including a housing 120 (for example, the housing 120 of FIG. 1) and a heating element 200. Components of the aerosol generating system 1000 according to an embodiment may be substantially the same as or similar to at least one of the components of the aerosol generating system 1000 illustrated in FIG. 1, and redundant descriptions thereof are omitted below.

The heating element 200 may generate an aerosol by heating the aerosol generating article 110 inserted into or accommodated in the housing 120 through an opening 100h. The heating element 200 may heat the aerosol generating article 110, for example, by generating heat with received power.

In this case, an aerosol may be generated by mixing vaporized particles generated by heating the aerosol generating article 110 with air introduced into the housing 120 through the opening 100h.

According to one embodiment, the heating element 200 may include an induction heating type heater. For example, the heating element 200 may include a coil 201 (or an ‘electrically conductive coil’) for supplying a magnetic field that changes according to the supplied power and a susceptor 202 that generates heat by the changing magnetic field generated by the coil 201, and may heat the aerosol generating article 110 accommodated in the housing 120 by using an induction heating method.

When the aerosol generating article 110 is accommodated in the housing 120, the susceptor 202 is arranged to surround at least a part of an outer circumferential surface of the aerosol generating article 110 to heat the aerosol generating article 110 accommodated in the housing 120. The susceptor 202 may generate heat by, for example, an alternating magnetic field generated by the coil 201, and as a result, the aerosol generating article 110 may be heated.

According to one example, the susceptor 202 may be arranged to surround at least a part of an outer circumferential surface of a medium portion including an aerosol generating material in the aerosol generating article 110, and the coil 201 may be arranged to surround at least a part of the outer circumferential surface of the susceptor 202, and accordingly, the aerosol generating article 110 accommodated in the housing 120 may generate an aerosol through heating.

According to another embodiment, the heating element 200 may include an electrical resistive heater. For example, the heating element 200 may include a film heater arranged to cover at least a part of an outer circumferential surface of the aerosol generating article 110 accommodated in the housing 120. The film heater may include an electrically conductive track, and as a current flows through the electrically conductive track, the film heater may generate heat to heat the aerosol generating article 110 inserted into the housing 120.

Also, according to another embodiment, the heating element 200 may include at least one of a needle-type heater, a rod-type heater, and a tube-type heater that may heat the inside of the aerosol generating article 110 accommodated in the housing 120. The heater described above may be inserted into, for example, at least one region of the aerosol generating article 110 to heat the inside of the aerosol generating article 110.

The heating element 200 is not limited to the embodiment described above, and the embodiment of the heating element 200 may be modified as long as the aerosol generating article 110 may be heated to a designated temperature. In the present disclosure, the ‘designated temperature’ may indicate a temperature at which an aerosol generating material included in the aerosol generating article 110 may be heated to generate an aerosol. The designated temperature may be a temperature preset in the aerosol generating device 100, but the corresponding temperature may be changed according to the type of the aerosol generating device 100 and/or a user's operation.

The heating element 200 may have a hollow tubular shape. The heating element 200 may be coaxial with the aerosol generating article 110 accommodated in an internal space of the housing 120 in the +z-axis direction.

A support portion 204 may be in the internal space of the housing 120. The support portion 204 may have a shape protruding from a bottom surface of the housing 120 in the +z-axis direction toward the internal space thereof. The support portion 204 may support at least one of the aerosol generating article 110 and the heating element 200.

According to one example, the support portion 204 may include a first support portion 204a supporting one end of the susceptor 202 and a second support portion 204b supporting the other end of the susceptor 202. The first support portion 204a may support at least one of at least one region of one end of the aerosol generating article 110 and at least one region of one end of the susceptor 202. The second support portion 204b may support at least one region of the other end of the susceptor 202.

By adjusting a position of the aerosol generating article 110 supported by the support portion 204 and/or a position of the heating element 200, a region that comes into contact with the heating element 200 and the aerosol generating article 110 may be adjusted. As the support portion 204 supports the aerosol generating article 110 and the heating element 200 such that the aerosol generating article 110 and the heating element 200 have different heights from each other from the bottom surface of the housing 120 in the +z-axis direction, the heating element 200 may heat a desired region of the aerosol generating article 110.

A heat insulation structure 256 may be arranged to surround an outer circumferential surface of the heating element 200 to prevent heat generated from the heating element 200 from being discharged to the outside, and accordingly, an ambient temperature of the heating element 200 may be maintained at a high temperature. In addition, the heat insulation structure 256 may seal the heating element 200 to prevent liquid droplets generated in an aerosol generation process from leaking out.

According to one embodiment, the heat insulation structure 256 may be arranged to surround one region (for example, a bottom surface and/or a side surface) of an outer circumferential surface of the heating element 200. The heat insulation structure 256 may include a first heat insulation structure 205 arranged to surround one region of an outer circumferential surface of the susceptor 202 and a second heat insulation structure 206 arranged to surround one region of an outer circumferential surface of the coil 201.

The susceptor 202 may be located in an internal space formed by the first heat insulation structure 205 and the second heat insulation structure 206, and the first heat insulation structure 205 and the second heat insulation structure 206 may seal the susceptor 202.

In one example, the second heat insulation structure 206 may include a vacuum insulation layer and may vacuum-insulate the susceptor 202 but is not limited thereto. In another example, the second heat insulation structure 206 may be coupled to at least one region of a lower end of the first heat insulation structure 205, or the first heat insulation structure 205 and the second heat insulation structure 206 may be integrally formed.

The heat insulation structure 256 may have a substantially hollow tubular shape. The aerosol generating article 110, the susceptor 202, the coil 201, and the heat insulation structure 256 which are accommodated in the housing 120 may be coaxial with each other in the +z-axis direction.

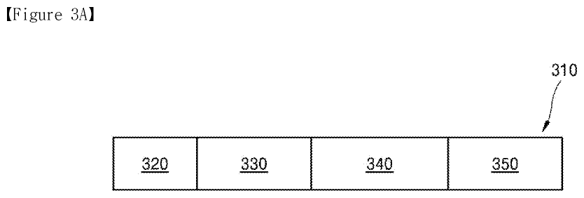

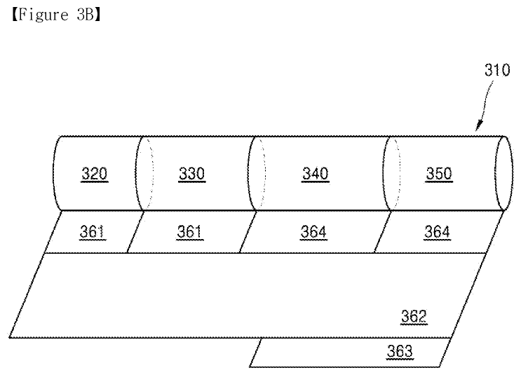

FIGS. 3A and 3B illustrate an aerosol generating article according to one embodiment.

Referring to FIG. 3A, an aerosol generating article 310 may include a first medium portion 330, a second medium portion 320, a cooling portion 340 and a filter portion 350. For example, the filter portion 350 may be a filter formed of cellulose acetate, and the cooling portion 340 and the filter portion 350 may include capsules and flavoring agents. The aerosol generating article 310 may or may not include a thermal conductor depending on a method of heating the aerosol generating article 310.

The first medium portion 330 may include nicotine. The first medium portion 330 may be composed of a cut tobacco in which a tobacco sheet is cut into small pieces. For example, the first medium portion 330 may include a material in which cut tobacco and a reconstituent tobacco sheet are mixed in a ratio of about 4:1, but is not limited to the mixing ratio described above.

The second medium portion 320 may include a material that causes atomization. For example, the second medium portion 320 may include at least one of glycerin, propylene glycol, ethylene glycol, dipropylene glycol, diethylene glycol, triethylene glycol, tetraethylene glycol, and oleyl alcohol, but is not limited thereto. In addition, the second medium portion 320 may not include nicotine.

The cooling portion 340 may provide an aerosol cooled to an appropriate temperature to a user by generating an effect of reducing the temperature of the generated aerosol. For example, the cooling portion 340 may include cellulose acetate and may have a hollow tubular structure. However, the cooling portion is not limited to the example described above and may be used without limitation as long as there is an effect of cooling an aerosol.

The filter portion 350 may include at least one capsule. For example, the capsule may include a flavoring liquid, and as the capsule is broken, flavor may be generated by the leaked flavoring liquid, but the capsule is not limited thereto.

Referring to FIG. 3B, a wrapper 361 or wrapping paper 364 may surround an outer circumferential surface of the aerosol generating article 310. For example, the wrapper 361 may surround the second medium portion 320 and the first medium portion 330 and may be a thermally conductive wrapper depending on heating methods. For example, the wrapper may be made of metal foil such as aluminum foil, but is not limited thereto.

According to one example, the wrapping paper 364 may have water resistance and/or oil resistance to prevent a material from being leaked to the outside of the aerosol generating article 310 as a capsule included in the aerosol generating article 310 is broken. However, the wrapping paper is not limited thereto.

Referring to FIG. 3B, an outer cover 362 may surround outer circumferential surfaces of the wrapper 361 and the wrapping paper 364. In addition, in order to prevent the outer cover 362 from getting wet by an aerosol, a user's breath, saliva, or so on generated while a user inhales the aerosol, a tipping paper 363 may surround an outer circumferential surface of the outer cover 362 surrounding the wrapper 364.

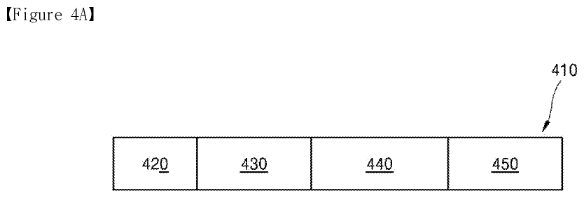

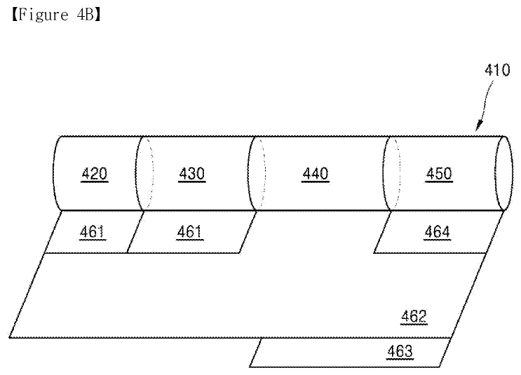

FIGS. 4A and 4B illustrate an aerosol generating article according to another embodiment.

An aerosol generating article 410 illustrated in FIGS. 4A and/or 4B may be an aerosol generating article obtained by changing only the first medium portion 330 or the wrapping paper 364 from the aerosol generating article 310 illustrated in FIGS. 3A and/or 3B, and redundant descriptions thereof are omitted below.

Referring to FIG. 4A, the aerosol generating article 410 may include a first medium portion 430, a second medium portion 420, a cooling portion 440, and a filter portion 450. The second medium portion 420 may include a material that causes atomization. For example, the second medium portion 420 may include only glycerin, but is not limited thereto.

Compared to FIG. 3A, the first medium portion 430 may be a crimped sheet in which a nicotine solution is impregnated. For example, the crimped sheet may be a paper sheet that does not generate off-flavor due to heat even when heated to a high temperature, but is not limited thereto.

Referring to FIG. 4B, a wrapper 461 or wrapping paper 464 may surround an outer circumferential surface of the aerosol generating article 410. Compared to FIG. 3B, the wrapping paper 464 may be arranged to surround only the filter portion 450.

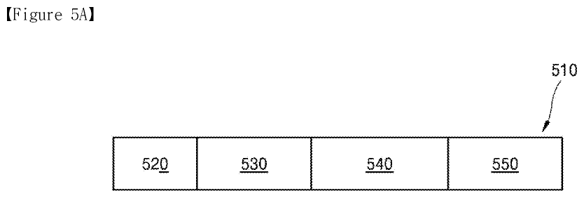

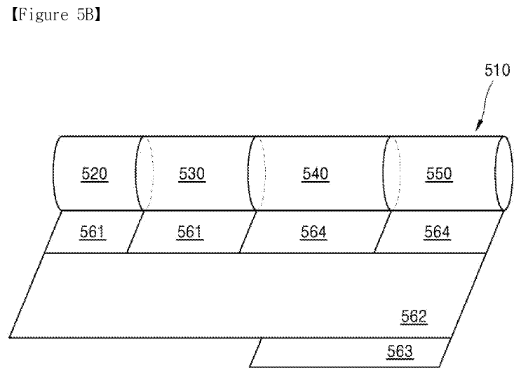

FIGS. 5A and 5B illustrate an aerosol generating article according to another embodiment.

An aerosol generating article 510 illustrated in FIGS. 5A and/or 5B may be an aerosol generating article obtained by changing only the first medium portion 330 from the aerosol generating article 310 illustrated in FIGS. 3A and/or 3B, and redundant descriptions thereof are omitted below.

Referring to FIG. 5A, the aerosol generating article 510 may include a first medium portion 530, a second medium portion 520, a cooling portion 540, and a filter portion 550. The second medium portion 520 may include a material that causes atomization. For example, the second medium portion 520 may include only glycerin, but is not limited thereto.

Compared to FIG. 3A, the first medium portion 530 may include a plurality of tobacco granules. The plurality of tobacco granules may refer to a plurality of spherical particles including tobacco materials. The plurality of tobacco granules may be embedded between the filter materials. For example, the first medium portion 530 may include a paper sheet, and the plurality of tobacco granules may be uniformly dispersed inside the wound paper sheet, but is not limited thereto.

Referring to FIG. 5B, a wrapper 561 or wrapping paper 564 may surround an outer circumferential surface of the aerosol generating article 510.

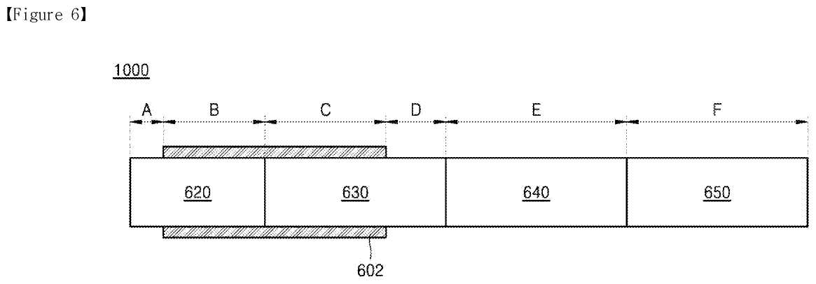

FIG. 6 is a view illustrating an aerosol generating system according to an embodiment. In FIG. 6, a length of the second medium portion 620, a length of the first medium portion 630, a length of the cooling portion 640, and a length of the filter portion 650 are respectively denoted as A+B, C+D, E, and F. In this case, the expression ‘length’ may indicate a length by which the second medium portion 620, the first medium portion 630, the cooling portion 640, and/or the filter portion 650 extend in a longitudinal direction (for example, the z direction in FIG. 1 or 2) of an aerosol generating article, and the expression may be used in the same meaning below.

Referring to FIG. 6, an aerosol generating system 1000 may include the second medium portion 620, the first medium portion 630, the cooling portion 640, the filter portion 650, and a susceptor 602.

According to one embodiment, the first medium portion 630 may be arranged adjacent to one end of the second medium portion 620, the cooling portion 640 may be arranged adjacent to one end of the first medium portion 630, and the filter portion 650 may be arranged adjacent to one end of the cooling portion 640.

The length A+B of the second medium portion 620 may be appropriately selected within a range of about 8 mm to about 12 mm, but is not limited thereto. Preferably, the length A+B of the second medium portion 620 may be about 10 mm, but is not limited thereto. A diameter of the second medium portion 620 may be appropriately selected within a range of about 7 mm to about 7.4 mm, but is not limited thereto. Preferably, the diameter of the second medium portion 620 may be about 7.2 mm, but is not limited thereto.

The length C+D of the first medium portion 630 may be appropriately selected within a range of about 10 mm to about 14 mm, but is not limited thereto. Preferably, the length C+D of the first medium portion 630 may be about 12 mm, but is not limited thereto. A diameter of the first medium portion 630 may be appropriately selected within a range of about 7 mm to about 7.4 mm, but is not limited thereto. Preferably, the diameter of the first medium portion 630 may be about 7.2 mm, but is not limited thereto.

The length E or a diameter of the cooling portion 640 may change depending on shapes of the aerosol generating article. For example, the length E of the cooling portion 640 may be appropriately selected within a range of about 10 mm to about 14 mm. Preferably, the length E of the cooling portion 640 may be about 12 mm, but is not limited thereto. The diameter of the cooling portion 640 may be appropriately selected within a range of about 7 mm to about 7.4 mm, but is not limited thereto. Preferably, the diameter of the cooling portion 640 may be about 7.2 mm, but is not limited thereto.

The length F of the filter portion 650 may be appropriately selected within a range of about 12 mm to about 16 mm, but is not limited thereto. Preferably, the length F of the filter portion 650 may be about 14 mm, but is not limited thereto. A diameter of the filter portion 650 may be appropriately selected within a range of about 7 mm to about 7.4 mm, but is not limited thereto. Preferably, the diameter of the filter portion 650 may be about 7.2 mm, but is not limited thereto.

The susceptor 602 may be arranged to surround at least a part of the second medium portion 620 and a part of the first medium portion 630 and may generate heat by an alternating magnetic field generated by a coil (for example, the coil 201 of FIG. 2) to heat at least some regions of the second medium portion 620 and the first medium portion 630.

In FIG. 6, the total length of the susceptor 602 may be represented as B+C. In this case, a length of the susceptor 602 arranged to surround an outer circumferential surface of the second medium portion 620 to heat the second medium portion 620 is denoted as B, and a length of the susceptor 602 arranged to surround an outer circumferential surface of the first medium portion 630 to heat the first medium portion 630 is denoted as C.

The total length B+C of the susceptor 602 may be appropriately selected within a range of about 12 mm to about 16 mm, but is not limited thereto. Preferably, the total length B+C of the susceptor 602 may be about 14 mm, but is not limited thereto. A diameter of the susceptor 602 may be appropriately selected within a range of about 7 mm to about 7.4 mm, but is not limited thereto. Preferably, the diameter of the susceptor 602 may be about 7.27 mm, but is not limited thereto.

In the aerosol generating system 1000 according to an embodiment, regions of outer peripheral surfaces of the first medium portion 630 and the second medium portion 620 surrounded by the susceptor 602 and/or regions of an outer circumferential surface of the susceptor 602 surrounded by a coil may be various. The quality of the generated aerosol may change depending on areas or positions of the outer circumferential surfaces of the first medium portion 630 and the second medium portion 620 surrounded by the susceptor 602 and/or areas or positions of the outer circumferential surface of the susceptor 602 surrounded by the coil. In the present disclosure, ‘quality of an aerosol’ may refer to the amount of generated aerosol and/or inhalation resistance that a user may feel when inhaling an aerosol, and the expression may be used in the same meaning below.

In the aerosol generating system 1000 according to an embodiment, a partial region of an outer circumferential surface of the first medium portion 630 and a partial region of an outer circumferential surface of the second medium portion 620 may be arranged to be surrounded by one susceptor 602 and one coil. As an aerosol generating article is heated by using one susceptor 602 and one coil, a structure of the aerosol generating device may be simplified and a weight of the aerosol generating device may be reduced.

The inhalation resistance may refer to the force that a user inhales an aerosol when smoking, and in order to experimentally provide a stable sense of smoking to the user, a magnitude of the inhalation resistance needs to be maintained at about 6 mmWG.

In the aerosol generating system 1000 according to an embodiment, the inhalation resistance may be adjusted by differently setting the length C of the first medium portion 630 of which outer circumferential surface is surrounded by the susceptor 602 from the length B of the second medium portion 620 of which outer circumferential surface is surrounded by the susceptor 602, and accordingly, the inhalation resistance that may improve a sense of smoking of a user may be maintained.

For example, as an area of the first medium portion 630 heated by the susceptor 602 increases, pores in the first medium portion 630 may be expanded, and as a result, the magnitude of inhalation resistance may be reduced. In addition, as an area of the second medium portion 620 heated by the susceptor 602 is reduced, the heat transferred to the first medium portion 630 is reduced, and accordingly, the pores in the first medium portion 630 may be reduced, and as a result, the magnitude of inhalation resistance may increase.

That is, when the length C of the first medium portion 630 of which outer circumferential surface is surrounded by the susceptor 602 is greater than the length B of the second medium portion 620 of which outer circumferential surface is surrounded by the susceptor 602, the magnitude of inhalation resistance may be reduced, but when the length B of the second medium portion 620 of which outer circumferential surface is surrounded by the susceptor 602 is reduced too much, the magnitude of inhalation resistance may rather increase.

Accordingly, in the aerosol generating system 1000 according to an embodiment, by adjusting a ratio of the length C of the first medium portion 630 of which outer circumferential surface is surrounded by the susceptor 602 to the length B of the second medium portion 620 of which outer circumferential surface is surrounded by the susceptor 602, it is possible to implement the inhalation resistance for providing the best smoking experience to a user.

For example, in the aerosol generating system 1000 according to an embodiment, by adjusting a ratio of the length C of the first medium portion 630 of which outer circumferential surface is surrounded by the susceptor 602 to the length B of the second medium portion 620 of which outer circumferential surface is surrounded by the susceptor 602, the magnitude inhalation resistance may be maintained at about 6 mmWG for providing the best smoking experience.

Hereinafter, a change in inhalation resistance according to the ratio of the length C of the first medium portion 630 of which outer circumferential surface is surrounded by the susceptor 602 to the length B of the second medium portion 620 of which outer circumferential surface is surrounded by the susceptor 602 is described by referring to Table 1.

In Table 1, Example 1 illustrates that the length C of the first medium portion 630 of which outer circumferential surface is surrounded by the susceptor 602 is 7 mm, the length B of the second medium portion 620 of which outer circumferential surface is surrounded by the susceptor 602 is 7 mm, and a ratio of the length C of the first medium portion 630 of which outer circumferential surface is surrounded by the susceptor 602 to the length B of the second medium portion 620 of which outer circumferential surface is surrounded by the susceptor 602 is 1:1.

In addition, Example 2 illustrates that the length C of the first medium portion 630 is 8 mm, the length B of the second medium portion 620 of which outer circumferential surface is surrounded by the susceptor 602 is 7 mm, and a ratio of the length C of the first medium portion 630 of which outer circumferential surface is surrounded by the susceptor 602 to the length B of the second medium portion 620 of which outer circumferential surface is surrounded by the susceptor 602 is 1.3:1.

In addition, Example 3 illustrates that the length C is 9 mm, the length B of the second medium portion 620 of which outer circumferential surface is surrounded by the susceptor 602 is 5 mm, and a ratio of the length C of the first medium portion 630 of which outer circumferential surface is surrounded by the susceptor 602 to the length B of the second medium portion 620 of which outer circumferential surface is surrounded by the susceptor 602 is 1.8:1.

### EXPERIMENTAL EXAMPLE 1: INHALATION RESISTANCE MAGNITUDE MEASUREMENT EXPERIMENT

150 (100%) aerosol generating systems 1000 arranged as in Example 1 to Example 3 were prepared, and aerosols were generated to measure inhalation resistance (mmWG) generated when a user inhaled the generated aerosol. The measurement result is as follows.

In the aerosol generating system 1000 of Example 1, one inhalation resistance (0.7%) was measured as 5 mmWG, 42 inhalation resistances (28.0%) were measured as 6 mmWG, 107 inhalation resistances (71.3%) were measured as 7 mmWG, and an average resistance was measured as 6.71 mmWG. In the aerosol generating system 1000 of Example 2, four inhalation resistances (2.7%) were measured as 5 mmWG, 119 inhalation resistances (79.3%) were measured as 6 mmWG, 27 inhalation resistances (19.0%) were measured as 7 mmWG, and an average resistance was measured as 6.15 mmWG. In the aerosol generating system 1000 of Example 3, three inhalation resistances (2.0%) were measured as 5 mmWG, 62 inhalation resistances (41.3%) were measured as 6 mmWG, 85 inhalation resistances (56.7%) were measured as 7 mmWG, and an average resistance was measured as 6.57 mmWG. The measured inhalation resistance is illustrated in Table 1 below.

TABLE 1

| | The number | The number | The number | |
|---|---|---|---|---|
| | (ratio) of | (ratio) of | (ratio) of | Average |
| | inhalation | inhalation | inhalation | inhalation |
| | resistances of | resistances of | resistances of | resistance |
| | 5 mmWG | 6 mmWG | 7 mmWG | (mmWG) |
| Example 1 | 1 (0.7%) | 42 (28.0%) | 107 (71.3%) | about 6.71 |
| Example 2 | 4 (2.7%) | 119 (79.3%) | 27 (18.0%) | about 6.15 |
| Example 3 | 3 (2.0%) | 62 (41.3%) | 85 (56.7%) | about 6.57 |

Referring to Table 1, it may be seen, in the aerosol generating system 1000 according to an embodiment, that, when a ratio of the length C of the first medium portion 630 of which outer circumferential surface is surrounded by the susceptor 602 to the length B of the second medium portion 620 of which outer circumferential surface is surrounded by the susceptor 602 is less than 1:1 or greater than 1.8:1, the magnitude of inhalation resistance increases as described above. Therefore, it may be seen that it is possible to implement the inhalation resistance for providing the best smoking experience to a user within a range in which a ratio of the length C of the first medium portion 630 of which outer circumferential surface is surrounded by the susceptor 602 to the length B of the second medium portion 620 of which outer circumferential surface is surrounded by the susceptor 602 is from 1:1 to 1.8:1, and in particular, when the ratio is 1.4:1, the inhalation resistance of about 6.15 mmWG may be implemented.

The aerosol generating system 1000 may generate multiple aerosols from a single aerosol generating article. For example, in the aerosol generating system 1000, the amount of atomization generated while a user performs several puff actions for one aerosol generating article may not be constant.

The less the deviation in the amount of atomization generated while the several puff actions are performed, the more the continuity of the aerosol generating system 1000 may be increased.

The aerosol generating system 1000 according to an embodiment may include a region where the susceptor 602 surrounds an outer circumferential surface of the first medium portion 630 and a region where the susceptor 602 does not surround the outer circumferential surface of the first medium portion 630. For example, a ratio between the two regions may be represented as a ratio of the length C of the first medium portion 630 of which outer circumferential surface is surrounded by the susceptor 602 to the length D of the first medium portion 630 of which outer circumferential surface is not surrounded by the susceptor 602.

In the aerosol generating system 1000 according to an embodiment, when an initial puff action (for example, 1 to 7 puff actions) is performed, an aerosol may be generated from a first region (for example, the region C of FIG. 6) of the first medium portion 630 in contact with the susceptor 602, and when a later puff action (for example, 8 to 14 puff actions) is performed, an aerosol may be generated from a second region (for example, the region D of FIG. 6) of the first medium portion 630 that is not in contact with the susceptor 602. For example, during the initial puff action, an aerosol may be mainly generated from the first region of the first medium portion 630 by being directly heated by the susceptor 602, and during the later puff action, an aerosol may be mainly generated from the second region of the first medium portion 630 by heat conducted by the susceptor 602.

As the length C of the first medium portion 630 of which outer circumferential surface is surrounded by the susceptor 602 is longer, the amount of initially generated aerosol may be abundant. In addition, as the length D of the first medium portion 630 of which outer circumferential surface is not surrounded by the susceptor 602 is reduced, the amount of aerosol generated later may be reduced. That is, in the aerosol generating system 1000, the continuity of the amount of atomization provided to a user may change according to a ratio of the length C of the first medium portion 630 of which outer circumferential surface is surrounded by the susceptor 602 to the length D of the first medium portion 630 of which outer circumferential surface is not surrounded by the susceptor 602.

As the amount of atomization is continuously generated while several puff actions are performed, a user may be provided with a better smoking experience. A uniform amount of atomization may be provided to a user during the puff action by adjusting a ratio of the length C of the first medium portion 630 of which outer circumferential surface is surrounded by the susceptor 602 to the length D of the first medium portion 630 of which outer circumferential surface is not surrounded by the susceptor 602. For example, the deviation in the amount of atomization generated during the puff action may be greatly reduced by adjusting the ratio of the length C of the first medium portion 630 of which outer circumferential surface is surrounded by the susceptor 602 to the length D of the first medium portion 630 of which outer circumferential surface is not surrounded by the susceptor 602.

The aerosol generating system 1000 according to an embodiment may heat one aerosol generating article including both the first medium portion 630 and the second medium portion 620 by using one susceptor 602 and one coil, the susceptor 602 may be arranged to surround only some regions of the first medium portion 630 and the second medium portion 620, and by adjusting a ratio of the length C of the first medium portion 630 of which outer circumferential surface is surrounded by the susceptor 602 to the length D of the first medium portion 630 of which outer circumferential surface is not surrounded by the susceptor 602, the amount of atomization may be continuously generated without providing additional components.

In order to heat the first medium portion 630 and the second medium portion 620 to a desired temperature or to generate a desired amount of atomization, the susceptor 602 or a coil may be additionally arranged. However, the aerosol generating system 1000 may achieve simplification of a structure and a light weight of a device while continuously generating the best amount of atomization without additionally arranging the susceptor 602 or a coil by adjusting a ratio of the length C of the first medium portion 630 of which outer circumferential surface is surrounded by the susceptor 602 to the length D of the first medium portion 630 of which outer circumferential surface is not surrounded by the susceptor 602.

Hereinafter, referring to Table 2, uniformity of the amount of atomization during the puff action according to the ratio of the length C of the first medium portion 630 of which outer circumferential surface is surrounded by the susceptor 602 to the length D of the first medium portion 630 of which outer circumferential surface is not surrounded by the susceptor 602 is described.

Example 1 to Example 3 in Table 2 use the same aerosol generating article as Example 1 to Example 3 in Table 1, and redundant descriptions thereof are omitted below.

### EXPERIMENTAL EXAMPLE 2: ATOMIZATION CONTINUITY EVALUATION EXPERIMENT

The aerosol generating system 1000 arranged as in Example 1 to Example 3 were operated a total of 14 puffs, and the amount of atomization generated per puff action was measured. It was assumed that a user inhaled an aerosol of 55cc per puff action for 1.5 seconds. The measured results are as follows.

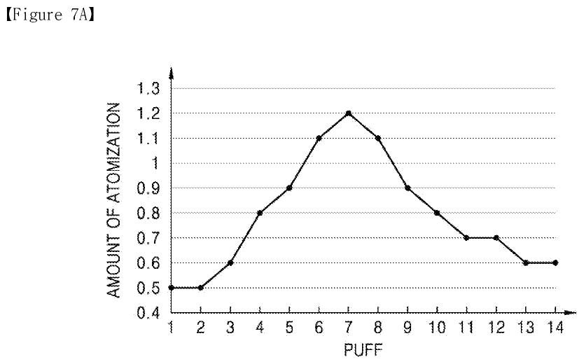

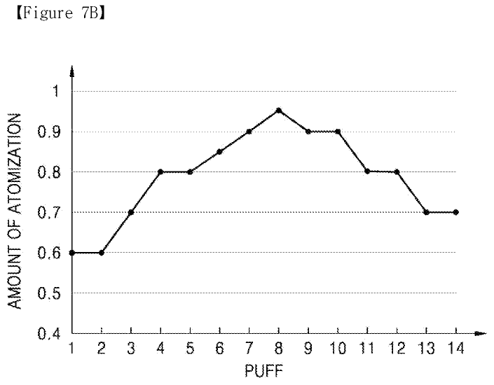

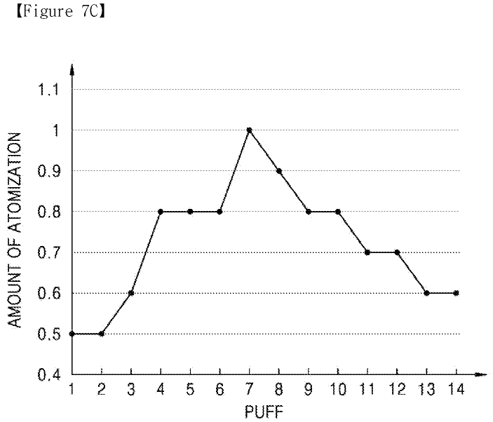

FIG. 7A is a graph illustrating a relative change in the amount of atomization according to a puff action of an aerosol generating system according to Example 1. In the aerosol generating system 1000 of Example 1, the greatest value of the amount of generated atomization is 1.2, the smallest value of the amount of generated atomization is 0.50, and a deviation is 0.70. FIG. 7B is a graph illustrating a relative change in the amount of atomization according to a puff action of the aerosol generating system according to Example 2. In the aerosol generating system 1000 of Example 2, the greatest value of the amount of generated atomization is 0.99, the smallest value of the amount of generated atomization is 0.60, and a deviation is 0.39. FIG. 7C is a graph illustrating a relative change in the amount of atomization according to a puff action of the aerosol generating system according to Example 3. In the aerosol generating system 1000 of Example 3, the greatest value of the amount of generated atomization is 1.0, the smallest value of the amount of generated atomization is 0.50, and a deviation is 0.50. The measured amount of atomization is illustrated in Table 2 below.

TABLE 2

| | greatest value | smallest value | deviation |
|---|---|---|---|
| Example 1 | 1.2 | 0.50 | 0.70 |
| Example 2 | 0.99 | 0.60 | 0.39 |
| Example 3 | 1.0 | 0.50 | 0.50 |

Referring to Table 2, it may be seen, in the aerosol generating system 1000 according to an embodiment, that, when a ratio of the length C of the first medium portion 630 of which outer circumferential surface is surrounded by the susceptor 602 to the length D of the first medium portion 630 of which outer circumferential surface is not surrounded by the susceptor 602 is less than 1.4:1 or greater than 3:1, a deviation between the greatest value and the smallest value of the amount of generated atomization increases as described above. Therefore, it may be seen that the amount of atomization for providing the best smoking experience to a user may be continuously provided to the user within a range in which a ratio of the length C of the first medium portion 630 of which outer circumferential surface is surrounded by the susceptor 602 to the length D of the first medium portion 630 of which outer circumferential surface is not surrounded by the susceptor 602 is from 1.4:1 to 3:1, and in particular, when the ratio is 2:1, the amount of atomization with the smallest deviation may be continuously provided to the user during the puff action.

Referring to Table 1 and Table 2, in the aerosol generating system 1000 according to an embodiment, in order to implement the best inhalation resistance and generate a constant amount of atomization from one aerosol generating article while several puff actions are performed, a ratio of the length C of the first medium portion 630 of which outer circumferential surface is surrounded by the susceptor 602 to the length B of the second medium portion 620 of which outer circumferential surface is surrounded by the susceptor 602 may be within the range of 1:1 to 1.8:1 or preferably 1.4:1, and a ratio of the length C of the first medium portion 630 of which outer circumferential surface is surrounded by the susceptor 602 to the length D of the first medium portion 630 of which outer circumferential surface is not surrounded by the susceptor 602 may be within the range of 1.4:1 to 3:1 or preferably 2:1.

Accordingly, the ratio of the length B of the second medium portion 620 of which outer circumferential surface is surrounded by the susceptor 602 to the length A of the second medium portion 620 of which outer circumferential surface is not surrounded by the susceptor 602 may range from 1:1 to 2.3:1, preferably 2:3.

Mainstream smoke may refer to smoke inhaled into a user's mouth when the user smokes, and the temperature of the mainstream smoke needs to be maintained at about 50° C. to provide the user with the best smoking experience.

The aerosol generating system 1000 according to an embodiment may maintain the temperature of the mainstream smoke that may increase a sense of smoking of a user by adjusting a ratio of the length C of the first medium portion 630 of which outer circumferential surface is surrounded by the susceptor 602 to the length E of the cooling portion 640.

The temperature of the mainstream smoke may be affected by the degree to which the first medium portion 630 is heated, and as the length C of the first medium portion 630 of which outer circumferential surface is surrounded by the susceptor 602 increases, the temperature of the mainstream smoke may increase. In addition, the temperature of the mainstream smoke may be reduced as the length E of the cooling portion 640 increases.

For example, the aerosol generating system 1000 according to an embodiment may maintain the temperature of the mainstream smoke for providing the best smoking experience at 50° C. by adjusting a ratio of the length C of the first medium portion 630 of which outer circumferential surface is surrounded by the susceptor 602 to the length E of the cooling portion 640.

Hereinafter, a change in temperature of the mainstream smoke according to the ratio of the length C of the first medium portion 630 of which outer circumferential surface is surrounded by the susceptor 602 to the length E of the cooling portion 640 is described by referring to Table 3.

Example 1 to Example 3 in Table 3 use the same aerosol generating article as Example 1 to Example 3 in Table 1, and redundant descriptions thereof are omitted below.

### EXPERIMENTAL EXAMPLE 3: MAINSTREAM-SMOKE TEMPERATURE MEASUREMENT EXPERIMENT

Ten aerosol generating systems 1000 arranged as in Example 1 to Example 3 were prepared and aerosols were generated to measure the temperature (C) of generated mainstream smoke. The measured results are as follows.

In the aerosol generating system 1000 of Example 1, the lowest temperature of the mainstream smoke was measured as 61.4° C., the highest temperature thereof was measured as 67.3° C., and an average temperature was measured as 64.1° C. In the aerosol generating system 1000 of Example 2, the lowest temperature of the mainstream smoke was measured as 62.2° C., the highest temperature thereof was measured as 68.1° C., and an average temperature was measured as 64.4° C. In the aerosol generating system 1000 of Example 3, the lowest temperature of the mainstream smoke was measured as 66.8° C., the highest temperature thereof was measured as 69.5° C., and an average temperature was measured as 65.4° C. The measured temperatures of the mainstream smoke are illustrated in Table 3 below.

TABLE 3

| | lowest | highest | average |
|---|---|---|---|
| | temperature | temperature | temperature |
| | (° C.) | (° C.) | (° C.) |
| Example 1 | 61.4 | 67.3 | 64.1 |
| Example 2 | 62.2 | 68.1 | 64.4 |
| Example 3 | 66.8 | 69.5 | 65.4 |

Referring to Table 3, it may be seen that, in the aerosol generating system 1000 according to an embodiment, that, as the length C of the first medium portion 630 of which outer circumferential surface is surrounded by the susceptor 602 increases, the temperature of the mainstream smoke increases as described above. Therefore, it may be seen, in the aerosol generating system 1000 according to an embodiment, that the best temperature of mainstream smoke may be provided to a user while implementing the best inhalation resistance and continuously generating the amount of smoke within a range in which a ratio of the length E of the cooling portion 640 to the length C of the first medium portion 630 of which outer circumferential surface is surrounded by the susceptor 602 is from 1.3:1 to 1.7:1, and in particular, when the ratio is 1.5:1, a deviation in the amount of smoke generated during a puff action may be greatly reduced and the temperature of mainstream smoke may be maintained at about 50° C. while maintaining the magnitude of inhalation resistance at about 6 mmWG.

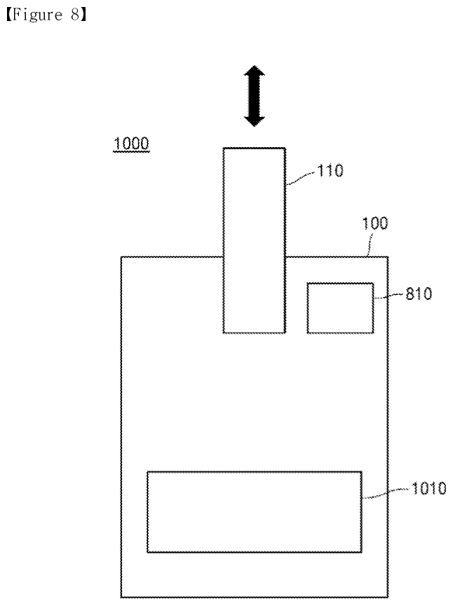

FIG. 8 is a diagram illustrating an aerosol generating system according to an embodiment.

Referring to FIG. 8, an aerosol generating system 1000 according to an embodiment may further include a sensor 810 and a processor 1010. According to one example, the sensor 810 may be electrically or operatively connected to the processor 1010 and may be arranged adjacent to the opening 100h of the housing 120 to detect the type of an aerosol generating article 110 accommodated in the opening 100h and/or whether the aerosol generating article 110 is accommodated.

According to another example, the sensor 810 may detect an inductance value inside the housing 120 corresponding to the type of the aerosol generating article 110 accommodated in the opening 100h and/or whether the aerosol generating article 110 is accommodated or removed. The processor 1010 may obtain the inductance value corresponding to the type of the aerosol generating article 110 and/or whether the aerosol generating article 110 is accommodated or removed through the sensor 810 and may detect the type of the aerosol generating article 110 accommodated in the opening 100h and/or whether the aerosol generating article 110 is accommodated or removed based on the obtained inductance value.

In the aerosol generating system 1000 according to another embodiment, the processor 1010 may detect whether the aerosol generating article 110 is accommodated in the opening 100h through the sensor 810. For example, the processor 1010 may detect whether the aerosol generating article 110 is accommodated in or removed from the opening 100h through the sensor 810.

Although not illustrated, the aerosol generating article 110 may include a thermally conductive thin film therein. Accordingly, electrical characteristics in the housing 120 may change when the aerosol generating article 110 is accommodated in or removed from the opening 100h.

The processor 1010 may detect a change in electrical characteristics in the housing 120 through the sensor 810 and may detect whether the aerosol generating article 110 is accommodated in or removed from the opening 100h based on the detection result.

In the aerosol generating system 1000 according to another embodiment, the processor 1010 may detect the type of the aerosol generating article 110 accommodated in the opening 100h through the sensor 810. For example, the processor 1010 may detect, through the sensor 810, whether the aerosol generating article 110 accommodated in the opening 100h is the aerosol generating article of FIGS. 3A and 3B, the aerosol generating article of FIGS. 4A and 4B, or the aerosol generating article of FIGS. 5A and 5B.

As the aerosol generating article 110 includes a thermally conductive thin film therein, electrical characteristics in the housing 120 may change when the aerosol generating article 110 is accommodated in the opening 100h. The size, shape, material, and so on of the thermally conductive thin film included in the aerosol generating article 110 may be changed depending on the type of the aerosol generating article 110, and accordingly, electrical characteristics in the housing 120 may be changed depending on the type of the aerosol generating article 110 accommodated in the opening 100h.

The processor 1010 may detect a change in electrical characteristics in the housing 120 through the sensor 810 and detect the type of the aerosol generating article 110 accommodated in the opening 100h based on the detection result.

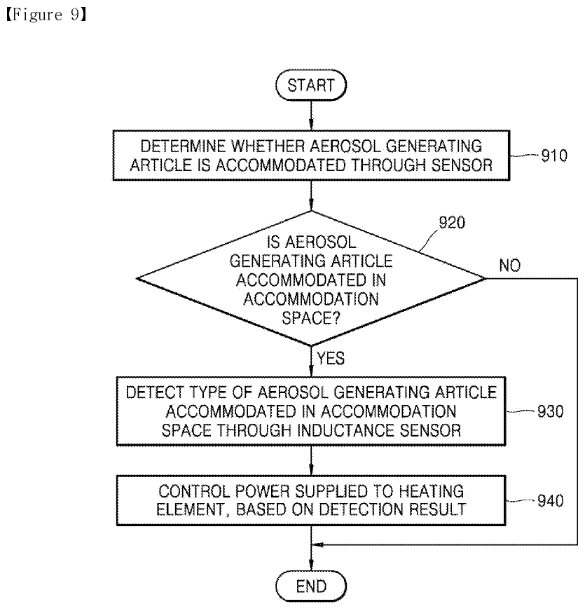

FIG. 9 is a flowchart illustrating an operating method of an aerosol generating device according to an embodiment. Hereinafter, in describing the operating method of the aerosol generating device illustrated in FIG. 9, the descriptions are given with reference to components of the aerosol generating system 1000 illustrated in FIG. 1 and/or FIG. 8.

Referring to FIG. 9, in operation 910, an aerosol generating device of the aerosol generating system 1000 according to an embodiment may determine whether the aerosol generating article 110 is accommodated through the sensor 810. When the aerosol generating article 110 is accommodated in an internal space through the opening 100h, the processor 1010 may detect a change in electrical characteristics in the housing 120 through the sensor 810, and detect whether the aerosol generating article 110 is accommodated in the housing 120 based on the detection result.

In operation 920, when it is determined that the aerosol generating article 110 is accommodated in an accommodation space through the opening 100h, operation 930 may be performed, and when it is determined that the aerosol generating article 110 is not accommodated in the accommodation space, the aerosol generating system 1000 may stop the processing without operation.

When it is determined in operation 920 that the aerosol generating article 110 is accommodated in the housing 120, the aerosol generating device of the aerosol generating system 1000 may detect the type of aerosol generating article 110 accommodated in the accommodation space in the housing 120 through an inductance sensor included in the sensor 810 in operation 930. The processor 1010 may detect, through the sensor 810, a change in electrical characteristics in the housing 120, which are different according to the type of the aerosol generating article 110 accommodated in an internal space through the opening 100h, and detect the type of the accommodated aerosol generating article 110 based on the detection result. For example, the processor 1010 may detect whether the accommodated aerosol generating article 110 is the aerosol generating article of FIGS. 3A and 3B, the aerosol generating article of FIGS. 4A and 4B, or the aerosol generating article of FIGS. 5A and 5B.

In operation 940, the aerosol generating device of the aerosol generating system 1000 may control the power supplied to the heating element 200 according to the type of the aerosol generating article 110 detected in operation 930. The processor 1010 may supply power to a heating element such that the heating element is heated according to a first temperature profile when a first aerosol generating article is accommodated in an accommodation space and may supply power to the heating element such that the heating element is heated according to a second temperature profile when a second aerosol generating article different from the first aerosol generating article is accommodated in the accommodation space. For example, a temperature profile corresponding to the aerosol generating article 110 of FIGS. 3A and 3B may be input by a user or preset in the aerosol generating system 1000, and when it is determined that the aerosol generating article 110 of FIGS. 3A and 3B is accommodated, the processor 1010 may control the power supplied to a coil such that the susceptor 602 generates heat according to the temperature profile.

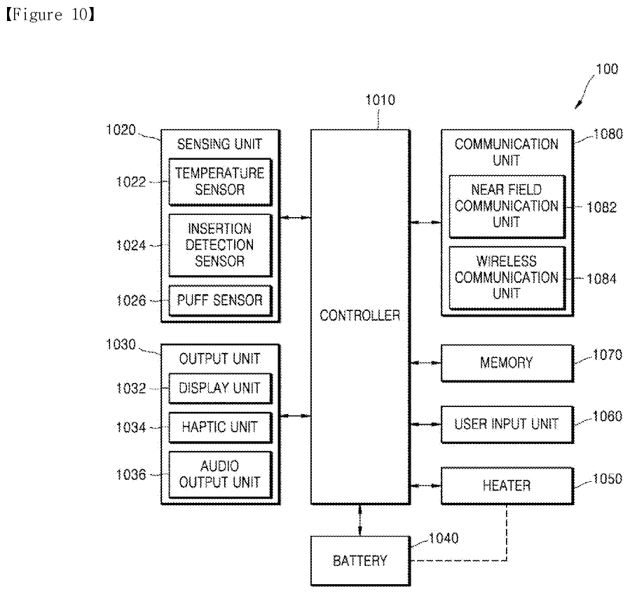

FIG. 10 is a block diagram of an aerosol generating device 100 according to another embodiment.

The aerosol generating device 100 may include a controller 1010, a sensing unit 1020, an output unit 1030, a battery 1040, a heater 1050, a user input unit 1060, a memory 1070, and a communication unit 1080. However, the internal structure of the aerosol generating device 100 is not limited to those illustrated in FIG. 10. That is, according to the design of the aerosol generating device 100, it will be understood by one of ordinary skill in the art that some of the components shown in FIG. 10 may be omitted or new components may be added.

The sensing unit 1020 may sense a state of the aerosol generating device 100 and a state around the aerosol generating device 100, and transmit sensed information to the controller 1010. Based on the sensed information, the controller 1010 may control the aerosol generating device 100 to perform various functions, such as controlling an operation of the heater 1050, limiting smoking, determining whether an aerosol generating article (e.g., a cigarette, a cartridge, or the like) is inserted, displaying a notification, or the like.

The sensing unit 1020 may include at least one of a temperature sensor 1022, an insertion detection sensor 1024, and a puff sensor 1026, but is not limited thereto.

The temperature sensor 1022 may sense a temperature at which the heater 1050 (or an aerosol generating material) is heated. The aerosol generating device 100 may include a separate temperature sensor for sensing the temperature of the heater 1050, or the heater 1050 may serve as a temperature sensor. Alternatively, the temperature sensor 1022 may also be arranged around the battery 1040 to monitor the temperature of the battery 1040.

The insertion detection sensor 1024 may sense insertion and/or removal of an aerosol generating article. For example, the insertion detection sensor 1024 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1026 may sense a user's puff on the basis of various physical changes in an airflow passage or an airflow channel. For example, the puff sensor 1026 may sense a user's puff on the basis of any one of a temperature change, a flow change, a voltage change, and a pressure change.

The sensing unit 1020 may include, in addition to the temperature sensor 1022, the insertion detection sensor 1024, and the puff sensor 1026 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1030 may output information on a state of the aerosol generating device 100 and provide the information to a user. The output unit 1030 may include at least one of a display unit 1032, a haptic unit 1034, and a sound output unit 1036, but is not limited thereto. When the display unit 1032 and a touch pad form a layered structure to form a touch screen, the display unit 1032 may also be used as an input device in addition to an output device.

The display unit 1032 may visually provide information about the aerosol generating device 100 to the user. For example, information about the aerosol generating device 100 may mean various pieces of information, such as a charging/discharging state of the battery 1040 of the aerosol generating device 100, a preheating state of the heater 1050, an insertion/removal state of an aerosol generating article, or a state in which the use of the aerosol generating device 100 is restricted (e.g., sensing of an abnormal object), or the like, and the display unit 1032 may output the information to the outside. The display unit 1032 may be, for example, a liquid crystal display panel (LCD), an organic light-emitting diode (OLED) display panel, or the like. In addition, the display unit 1032 may be in the form of a light-emitting diode (LED) light-emitting device.

The haptic unit 1034 may tactilely provide information about the aerosol generating device 100 to the user by converting an electrical signal into a mechanical stimulus or an electrical stimulus. For example, the haptic unit 1034 may include a motor, a piezoelectric element, or an electrical stimulation device.

The sound output unit 1036 may audibly provide information about the aerosol generating device 100 to the user. For example, the sound output unit 1036 may convert an electrical signal into a sound signal and output the same to the outside.

The battery 1040 may supply power used to operate the aerosol generating device 100. The battery 1040 may supply power such that the heater 1050 may be heated. In addition, the battery 1040 may supply power required for operations of other components (e.g., the sensing unit 1020, the output unit 1030, the user input unit 1060, the memory 1070, and the communication unit 1080) in the aerosol generating device 100. The battery 1040 may be a rechargeable battery or a disposable battery. For example, the battery 1040 may be a lithium polymer (LiPoly) battery, but is not limited thereto.

The heater 1050 may receive power from the battery 1040 to heat an aerosol generating material. Although not illustrated in FIG. 10, the aerosol generating device 100 may further include a power conversion circuit (e.g., a direct current (DC)/DC converter) that converts power of the battery 1040 and supplies the same to the heater 100. In addition, when the aerosol generating device 100 generates aerosols in an induction heating method, the aerosol generating device 100 may further include a DC/alternating current (AC) that converts DC power of the battery 1040 into AC power.

The controller 1010, the sensing unit 1020, the output unit 1030, the user input unit 1060, the memory 1070, and the communication unit 1080 may each receive power from the battery 1040 to perform a function. Although not illustrated in FIG. 10, the aerosol generating device 100 may further include a power conversion circuit that converts power of the battery 1040 to supply the power to respective components, for example, a low dropout (LDO) circuit, or a voltage regulator circuit.

In an embodiment, the heater 1050 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1050 may be implemented by a metal wire, a metal plate on which an electrically conductive track is arranged, a ceramic heating element, or the like, but is not limited thereto.

In another embodiment, the heater 1050 may be a heater of an induction heating type. For example, the heater 1050 may include a susceptor that heats an aerosol generating material by generating heat through a magnetic field applied by a coil.

The user input unit 1060 may receive information input from the user or may output information to the user. For example, the user input unit 1060 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 10, the aerosol generating device 100 may further include a connection interface, such as a universal serial bus (USB) interface, and may connect to other external devices through the connection interface, such as the USB interface, to transmit and receive information, or to charge the battery 1040.

The memory 1070 is a hardware component that stores various types of data processed in the aerosol generating device 100, and may store data processed and data to be processed by the controller 1010. The memory 1070 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1070 may store an operation time of the aerosol generating device 100, the maximum number of puffs, the current number of puffs, at least one temperature profile, data on a user's smoking pattern, etc.

The communication unit 1080 may include at least one component for communication with another electronic device. For example, the communication unit 1080 may include a short-range wireless communication unit 1082 and a wireless communication unit 1084.

The short-range wireless communication unit 1082 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1084 may include a cellular network communication unit, an Internet communication unit, a computer network (e.g., local area network (LAN) or wide area network (WAN)) communication unit, or the like, but is not limited thereto. The wireless communication unit 1084 may also identify and authenticate the aerosol generating device 100 within a communication network by using subscriber information (e.g., International Mobile Subscriber Identifier (IMSI)).

The controller 1010 may control general operations of the aerosol generating device 100. In an embodiment, the controller 1010 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1010 may control the temperature of the heater 1050 by controlling supply of power of the battery 1040 to the heater 1050. For example, the controller 1010 may control power supply by controlling switching of a switching element between the battery 1040 and the heater 1050. In another example, a direct heating circuit may also control power supply to the heater 1050 according to a control command of the controller 1010.

The controller 1010 may analyze a result sensed by the sensing unit 1020 and control subsequent processes to be performed. For example, the controller 1010 may control power supplied to the heater 1050 to start or end an operation of the heater 1050 on the basis of a result sensed by the sensing unit 1020. As another example, the controller 1010 may control, based on a result sensed by the sensing unit 1020, an amount of power supplied to the heater 1050 and the time the power is supplied, such that the heater 1050 may be heated to a certain temperature or maintained at an appropriate temperature.

The controller 1010 may control the output unit 1030 on the basis of a result sensed by the sensing unit 1020. For example, when the number of puffs counted through the puff sensor 1026 reaches a preset number, the controller 1010 may notify the user that the aerosol generating device 100 will soon be terminated through at least one of the display unit 1032, the haptic unit 1034, and the sound output unit 1036.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating system comprising:
an aerosol generating article, which includes a first medium portion including first aerosol generating materials, and a second medium portion arranged adjacent to one end of the first medium portion and including second aerosol generating materials; and
an aerosol generating device, which includes a housing including an accommodation space configured to accommodate the aerosol generating article, and a heating element arranged to surround at least a part of the aerosol generating article accommodated in the accommodation space to heat the aerosol generating article,
wherein an area of the heating element surrounding the first medium portion is different from an area of the heating element surrounding the second medium portion.

2. The aerosol generating system of claim 1, wherein the heating element comprises:
a coil that generates an alternating magnetic field; and
a susceptor which is arranged to surround at least a part of the first medium portion and at least a part of the second medium portion of the aerosol generating article accommodated in the accommodation space and heats the first medium portion and the second medium portion by generating heat by a magnetic field generated by the coil.

3. The aerosol generating system of claim 1, wherein a ratio of the area of the heating element surrounding the first medium portion to the area of the heating element surrounding the second medium portion is greater than 1:1 and less than or equal to 1.8:1.

4. The aerosol generating system of claim 1, wherein a ratio of the area of the heating element surrounding the first medium portion to an area of the heating element not surrounding the first medium portion is at least 1.4:1 and not more than 3:1.

5. The aerosol generating system of claim 1, wherein a ratio of the area of the heating element surrounding the second medium portion to an area of the heating element not surrounding the second medium portion is at least 1:1 and not more than 2.3:1.

6. The aerosol generating system of claim 1, wherein the aerosol generating article further comprises:
a cooling portion arranged adjacent to one end of the second medium portion to cool an aerosol; and
a filter portion arranged adjacent to one end of the cooling portion.

7. The aerosol generating system of claim 6, wherein a ratio of a length of the cooling portion in a longitudinal direction of the aerosol generating article to a length of a susceptor in contact with the first medium portion in the longitudinal direction of the aerosol generating article is at least 1.3:1 and not more than 1.7:1.

8. The aerosol generating system of claim 1, wherein the first medium portion includes nicotine and the second medium portion includes glycerin.

9. The aerosol generating system of claim 1, wherein the first medium portion comprises a paper filter including a nicotine solution, and the second medium portion includes glycerin.

10. The aerosol generating system of claim 1, wherein the first medium portion includes granules, and the second medium portion includes glycerin.

11. The aerosol generating system of claim 1, wherein the aerosol generating device further comprises a heat insulation structure arranged to surround an outer circumferential surface of the heating element and sealing the heating element to insulate heat generated from the heating element.

12. The aerosol generating system of claim 11, wherein
the heating element comprises a susceptor arranged to surround at least a part of the first medium portion and at least a part of the second medium portion of the aerosol generating article accommodated in the accommodation space to heat the aerosol generating article, and a coil that supplies a changing magnetic field to the susceptor, and
the heat insulation structure comprises a first heat insulation structure surrounding at least one region of an outer circumferential surface of the susceptor and arranged between the susceptor and the coil, and a second heat insulation structure arranged to surround an outer circumferential surface of the coil and including a vacuum tube.

13. The aerosol generating system of claim 1, wherein
the aerosol generating device further comprises a sensor for detecting whether the aerosol generating article is accommodated, and a processor electrically connected to the sensor, and
the processor detects whether the aerosol generating article is accommodated, based on a detection result of the sensor.

14. The aerosol generating system of claim 13, wherein
the sensor comprises an inductance sensor for detecting a type of the aerosol generating article accommodated in the accommodation space, and
the processor controls power supplied to the heating element, based on the detected type of the aerosol generating article accommodated in the accommodation space.

15. The aerosol generating system of claim 14, wherein the processor supplies power to the heating element to heat the heating element according to a first temperature profile, when a first aerosol generating article is accommodated in the accommodation space, and supplies power to the heating element to heat the heating element according to a second temperature profile, when a second aerosol generating article that is different from the first aerosol generating article is accommodated in the accommodation space.
